(19) United States
(12) Patent Application Publication
(10) Pub. No.: US 2011/0013757 A1
(43) Pub. Date: Jan. 20, 2011

(54) User programmable communication services

(76) Inventor: Bharat Kumar, Bridgewater, NJ (US)

Correspondence Address: Docket Administrator - Room 3D-201E;Alcatel-Lucent USA Inc., 600-700 Mountain Avenue, Murray Hill, NJ, 07974, US

(21) Appl. No.: 12/460,330

(22) Filed: Jul. 17, 2009

(51) Int. Cl. H04M 11/00

(52) U.S. Cl. 379/93.05

(57) ABSTRACT

It is desirable to a user who subscribes to one or more communication services (e.g., telephone, Internet and TV services, etc.) provided by a telecommunication service provider (telecom) can personalize his/her communication service. To that end, the telecom is receptive to programming code from a user subscribing to one or more communication services. The programming code is processed on the telecom side to realize a service application particular to the user which affects at least one communication service subscribed by the user.

### FIELD OF THE INVENTION

The invention relates to a technique for providing a communication service and, more particularly, to a technique for providing a customizable communication service.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

Telecommunication service providers (telecoms) including cable operators nowadays provide customers with packages of communication services including wireline and wireless telephone services, Internet and email services, television (TV) services, etc. Some of these telecoms allow customers to view and manage their accounts, and also to change certain service parameters online. For example, a customer may invoke a program provided by a telecom on its website to change a call forwarding number in his/her telephone service.

### BRIEF SUMMARY

The invention is premised upon a recognition that the trend of the telecommunication industry is migrating toward service customization by a user, thus reducing the workload of customer service. The typical telecom approach is “pushing” hardcoded programs to users for them to customize online specific service features which, a telecom believes, the users want to customize the most. Such a belief may be formed by second-guessing users' particular customization needs based, e.g., on anecdotal evidence from customer service calls. The shortcomings of the this approach thus are: (1) the second-guess may be correct only for those who called the customer service, but who do not represent the vast majority of the users, resulting in the guess being a “hit” or “miss” as far as an individual user is concerned; and (2) it takes time from collecting the anecdotal evidence to realizing the actual customization program, let alone the additional time it takes to publicize the new program.

Because of the above-identified shortcomings, the invention was conceived to supplant the ineffective approach of code pushing by a telecom. In accordance with an embodiment of the invention, in order to allow a user to personalize telecom services, and be in control of the service personalization in terms of the actual service features involved and the timing of its execution, a telecom needs to expose some of its facilities to a user, subject to his/her manipulation.

In one embodiment, the telecom is receptive to programming code from a user subscribing to one or more of the telecom services. The programming code is processed on the telecom side to realize a service application particular to the user which affects at least one telecom service subscribed by the user.

### BRIEF DESCRIPTION OF THE DRAWINGS

FIG. 1 is a block diagram of a communication arrangement where a user is able to transmit programming code to a telecommunication service provider network to realize a personalized service application in accordance with an embodiment of the invention;

FIG. 2 is a block diagram of a server used in the communication arrangement of FIG. 1;

FIG. 3 is a flowchart illustrating a process of creating programming code by a user for transmission to the telecommunication service provider network;

FIG. 4 illustrates a mashup program composed by a user in one embodiment;

FIG. 5 is a flowchart illustrating a process for carrying out a personalized user application based on the program of FIG. 4; and

FIG. 6 illustrates Java bytecode instrumentation for modifying Java bytecode provided by a user in one embodiment.

### DETAILED DESCRIPTION

The invention is directed to allowing a user of communication services (e.g., wireless and wireline telephone services, Internet and email services, TV services, etc.) provided by a telecommunication service provider (telecom) to create personalized service applications. The typical telecom approach is “pushing” hardcoded programs to users for them to customize specific service features online. The invention was conceived to supplant this typical approach which proves to be ineffective. In accordance with an embodiment of the invention, the telecom provisions a user programmable services framework which enables a user to directly inject user programming code or a plugin into this framework, thereby allowing the user to access selected resources and/or components of the communication services to realize a personalized experience.

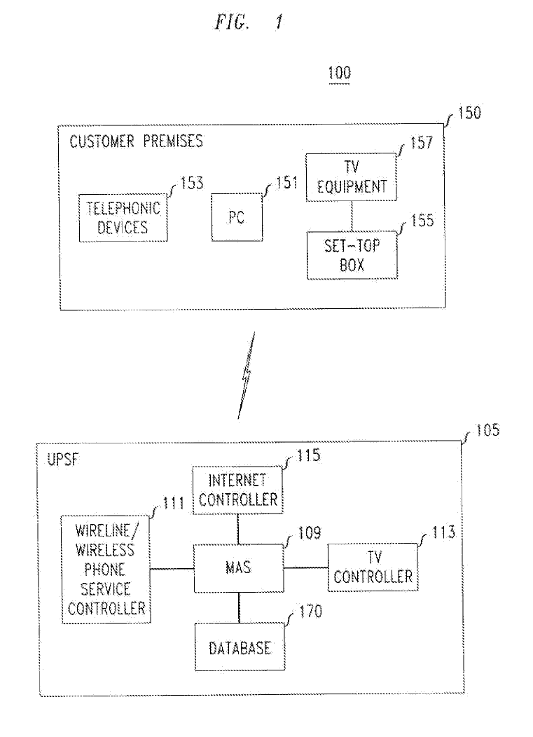

FIG. 1 illustrates a communication arrangement 100 embodying the principles of the invention. In this particular illustrative embodiment, the plugins created by a user may be referred to as “mashups,” which may be executable code or logic which, when executed, integrates data and functionality from multiple resources and/or components of the same or different communication services provided by Telco (a fictitious telecom), resulting in a new personalized service application. For example, a mashup may cause Telco to access on behalf of a user web services on the Internet, e.g., Google Maps and a yellow page service, to provide driving directions to the goods or service providers preferred by the user. Another mashup may cause Telco to access, on behalf of a user, phone numbers from the user's online address book (e.g., Yahoo! address book), and to integrate the phone numbers into selective-call-acceptance functionality in a phone service to create a “white list,” resulting in an automatic transfer of incoming calls from phone numbers other than those on the list directly to voicemail. Yet another mashup may cause Telco to create for a user a “blacklist,” whereby calls to a user from those phone numbers on the list would be automatically dropped, and the user would be notified of such calls via a pop-up on a TV screen.

In this instance, communication arrangement 100 includes customer premises 150 where a user named Bob subscribes and has access to a suite of communication services, e.g., wireless and wireline telephone services, Internet and email services, TV services, etc., provided by Telco. To utilize the suite of communication services, Bob at customer premises 150 has such user devices as personal computer (PC) 151 which may be a desktop, notebook or netbook computer, pocket personal computer (PPC), etc.; wireless and wireline telephonic devices 153 which may includes one or more of a corded phone, cordless phone, mobile phone, smart phone, iPhone®, personal digital assistant (PDA), Blackberry®-type device, Kindle™-type device, etc.; set-top box 155 provided by Telco to receive TV signals delivered thereby, and TV equipment 157 connected to box 155 for viewing TV programs thereon. Because of his service subscription with Telco, Bob in this instance may access the Internet not only with PC 151 but also an Internet enabled phone and set-top box 155.

Arrangement 100 also includes the aforementioned user programmable services framework (UPSF) 105 which is part of the Telco service provider network providing the communication services. Telco provisions an execution engine, e.g., mashup application server (MAS) 109, in UPSF 105 to run mashups created by a user, e.g., Bob, to realize new personalized service applications. In this illustrative embodiment, MAS 109 is connected to wireline/wireless phone service controller 111 capable of accessing multimedia and voice applications of the wireline and wireless telephone services provided by Telco, in accordance with a well known IP multimedia subsystem (IMS) architecture. For example, instructed by a user mashup, MAS 109 may communicate with controller 111 using session initiation protocol (SIP) over Internet protocol (IP) to provision personalized phone-related service applications. MAS 109 also is connected to TV service controller 113 capable of manipulating multimedia components of the TV service provided by Telco to set-top box 155 on customer premises 150. For example, instructed by a user mashup, MAS 109 may send from another source (e.g., a 3G wireless video communication from controller 111) to controller 113 multimedia content in a standard enhanced TV binary interchange format (EBIF) or, alternatively, in conformance to the well known TRU2WAY™ specifications to realize new TV-related service applications. In addition, MAS 109 is connected to Internet controller 115 for accessing the Internet resources sometimes on behalf of the users. In one embodiment, controller 115 maintains a Telco website on the Internet at a predetermined uniform resource locator (URL), e.g., telco.com, and a Telco user may establish a hypertext transfer protocol (HTTP) connection with controller 115 using a conventional web browser which may run on PC 151 on customer premises 150. Further, the Telco user may send aforementioned mashups to MAS 109 through controller 115 via one such HTTP connection.

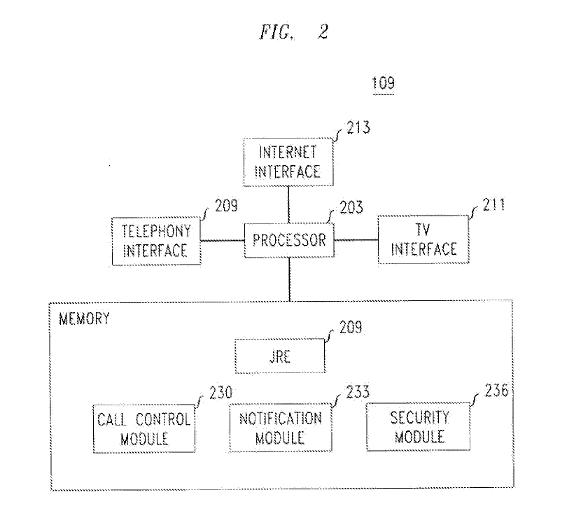

FIG. 2 illustrates MAS 109 in accordance with an embodiment of the invention. As shown in FIG. 2, MAS 109 comprises processor 203, memory 207, telephony interface 209 through which processor 203 communicates with wireline/wireless phone service controller 111 described above, TV interface 211 through which processor 203 communicates with TV service controller 113 described above, and Internet interface 213 through which processor 203 communicates with Internet controller 115 described above.

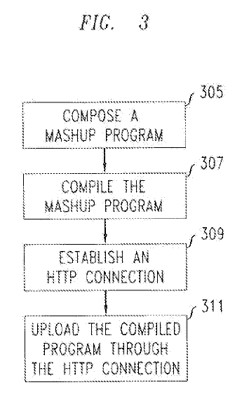

By way of example, but not limitation, each mashup in this illustrative embodiment is in the form of a Java application executable by processor 203 using Java runtime environment (JRE) 221 in memory 207. In one embodiment, Bob may utilize a text editor on PC 151 to compose a mashup program using Java programming language, with the aid of, e.g., tutorials on the Telco website, as indicated at step 305 in FIG. 3. In an alternative embodiment, Bob may utilize an integrated development environment (IDE), e.g., of the type of an Eclipse IDE, provided by Telco on its website or elsewhere which helps a user with the Java programming to develop the mashup program. In another embodiment, Telco may provide on its website graphical user interfaces (GUIs) to guide a user through the programming process to compose the mashup program.

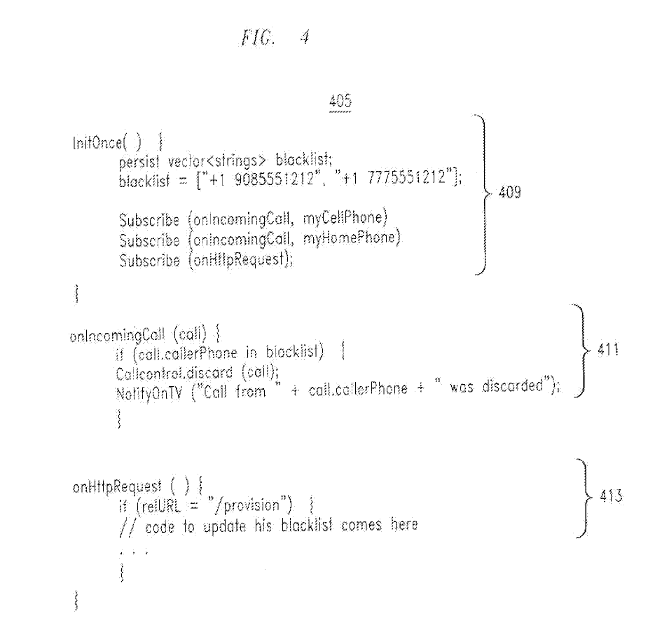

FIG. 4 illustrates one such mashup program 405 composed by Bob which is demonstrated in pseudo-code. In this example, program 405 is used to create a “blacklist,” whereby calls to Bob from those phone numbers on the blacklist would be discarded or dropped, and Bob would be notified of each discarded call via a pop-up on a TV screen. As shown in FIG. 4, program 405 includes program section 409 for initializing the program. According to section 409, a blacklist is initialized as a vector having string values “+1 9085551212” and “+1 7775551212,” which are the blacklisted phone numbers in this instance. In addition, the string values are made “persistent” so that such string values are to be stored in database 170 in UPSF 105, which should survive any crash of MAS 109. In one embodiment, the string values are to be stored in a parameter table in database 170, which would be associated with a user ID identifying Bob and a variable ID identifying the blacklist mashup.

Program section 409 also includes two subscriptions to an onIncomingCall routine with an object=“myCellPhone” in one subscription, and another object=“myHomePhone” in the other subscription. In other words, the onIncomingCall routine would be invoked whenever an incoming call to Bob's home or cell phone number is detected. At runtime, the objects “myCellPhone” and “myHomePhone” would be replaced by processor 203 with Bob's actual cell phone number and home phone number, respectively. Processor 203 may look up these phone numbers and any other user information stored in database 170 which are associated with Bob's user ID. In accordance with the onIncomingCall routine subscriptions, processor 203 would provision call control module 230 to detect any calls to Bob's home and cell phone numbers. In addition, program section 409 includes a subscription to an onHttpRequest routine, which is described below.

Program section 411 illustrates the onIncomingCall routine. According to this routine, if an incoming call detected by call control module 230 has an originating phone number which matches one of the blacklisted phone numbers, module 230 would be directed to automatically discard or drop the call. In addition, a NotifyOnTV routine would be invoked in section 411, whereby a video message “Call from [the originating phone number] was discarded” would be generated and popped up on the screen of Bob's TV equipment 157.

Program section 413 illustrates the onHttpRequest routine. According to this routine, processor 203 would monitor any Internet access by Bob to the relative URL “/provision” to update his blacklist thereat, in which case processor 203 incorporates any changes to Bob's blacklist accordingly. In this instance, the relative URL represents “mashaps/telco.com/bob/provision” which is its full version.

Referring back to FIG. 3, at step 307 Bob compiles mashup program 405 using a Java compiler on PC 151. The compiled program is referred to as “Bob's mashup” which includes Java bytecode to be executed by the JVM in JRE 221, and which represents instructions to be carried out by processor 203. As is well known, Java bytecode comprises opcodes which are one byte in length, some of which require parameters, resulting in multi-byte instructions. At step 309, Bob at the Telco website establishes an HTTP connection with Internet controller 115 in UPSF 105. At step 311, Bob uploads the compiled program, Bob's mashup, which comprises Java bytecode through the HTTP connection to Internet controller 115. The latter identifies Bob to be the originator of the mashup based on the IP address from which the HTTP connection was initiated, and which is known to be associated with Bob's user ID in database 170. Controller 115 transfers Bob's user ID, and the received Bob's mashup to MAS 109 for processing. In one embodiment, Bob's mashup is executed by processor 203 using JRE 221.

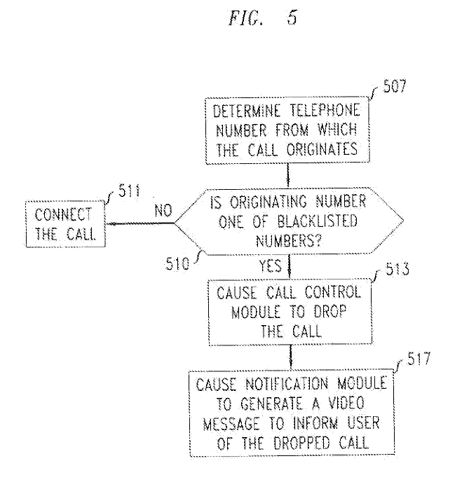

Let's assume in this instance that call control module 230 detects an incoming call to Bob's home or cell phone number. In accordance with Bob's mashup, processor 203 determines the telephone number from which the call originates based, e.g., on an automatic call identification (ANI) associated with the call, as indicated at step 507 in FIG. 5. At step 510, processor 203 determines whether the originating telephone number matches one of the telephone numbers on Bob's blacklist. If not, the call is connected to Bob's home or cell phone in the usual manner, as indicated at step 511. Otherwise if the originating number is one of the blacklisted numbers, processor 203 at step 513 causes call control module 230 to drop the call. Accordingly, the call is abruptly cut off and disconnected. In addition, at step 517 processor 203 causes notification module 233 to generate a video message to be popped up on the screen of Bob's TV equipment to inform Bob of the dropped call. The content of the message in this instance is “Call from [the originating phone number] was discarded.” Accordingly, the video message is transmitted to Bob's set-top box 155 through TV service controller 113 in the appropriate EBIF format in this instance. The address of set-top box 155 is stored in database 170 in association with Bob's user ID previously received by processor 203. Set-top box 155 is programmed to incorporate such a message into the video stream on the channel to which Bob's TV equipment 157 currently is tuned such that the message appears on the TV screen as a pop-up. In the event that TV equipment 157 is not turned on, the video message is buffered in set-top box 155 for notifying Bob later, along with a time-stamp indicating the time of receipt of the message.

It should be noted at this point that a Telco user is not given unbridled liberty to create whatever mashups the user desires. In fact, security measures are built into the Telco system to check the propriety of a user mashup. Such security measures may include imposing limits on CPU and memory consumption by a user mashup, and restrictions on the types of service interaction that can be invoked by a user mashup, etc., with the goal of protecting the Telco network resources and users from malicious or faulty user mashups.

For example, security measures may be built into the aforementioned IDE provided by Telco which helps a user compose a mashup program. The IDE provisioned with the security measures may statically check user mashup programs, and disallow those programs which contain seemingly malicious or faulty routines. One such routine may comprise a malicious loop, e.g., making a call to an emergency number “911” once every minute. Of course, a user would be stopped from compiling any mashup program disallowed by the IDE.

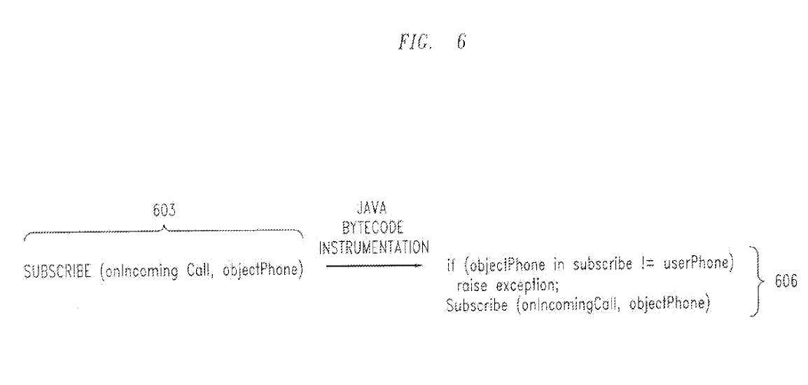

Security measures may also be built into MAS 109 to scrutinize a compiled mashup program received from a user, which comprises Java bytecode in this illustrative embodiment. For example, processor 203 may check the bytecode for particular routine subscriptions. One such subscription may be to the aforementioned onIncomingCall routine, i.e., Subscribe (onIncomingCall, objectPhone). As described earlier, such subscription would cause call control module 230 to monitor any incoming calls to the objectPhone number. In one embodiment, when the user mashup is received, processor 203 identifies the bytecode of the onIncomingCall subscription, represented by pseudo-code 603 in FIG. 6. Processor 203 then checks the objectPhone number in the subscription in the event that the objectPhone number has been specified by the user to be a particular phone number. In that case, processor 203 determines whether the particular phone number belongs to the user based on the user information stored in database 170. If not, processor 203 would raise an exception for security and privacy reasons, which may render the user mashup ineffective. To that end, through security module 236, processor 203 instruments the Java bytecode of the subscription in question. As is well known, Java bytecode instrumentation is a process where new functionality is added to a routine by modifying the original Java bytecode before it is executed. In this case, the instrumented Java bytecode, represented by pseudo-code 606, results from modifying the original Java bytecode, represented by pseudo-code 603, to include the condition for raising the above-described exception, i.e., when the objectPhone number is not one of the user's phone numbers. It should be noted that this instrumented bytecode also applies in case the objectPhone number is specified only at runtime, e.g., by retrieving it at a particular URL.

The foregoing merely illustrates the principles of the invention. It will thus be appreciated that those skilled in the art will be able to devise numerous arrangements which embody the principles of the invention and are thus within its spirit and scope.

For example, in one embodiment of the invention, a repository is provided in UPSF 105 for a Telco user to deposit copies of selected mashup programs created by him or her. Other users may retrieve from the repository one or more program copies to adopt and/or modify in composing their own programs. Similarly, Telco may provide sample programs in the repository for a user to adopt or modify.

Finally, although communication arrangement 100 and it various components, as disclosed, are embodied in the form of various discrete functional blocks, such a system and components could equally well be embodied in an arrangement in which the functions of any one or more of those blocks or indeed, all of the functions thereof, are realized, for example, by one or more appropriately programmed processors or devices.

What is claimed is:

1. A server for use by a communication service provider to provide communication services, comprising:
an interface for receiving programming code from a user subscribing to one or more communication services provided by the communication service provider; and
a processor configured to process the programming code to realize a service application particular to the user which affects at least one communication service subscribed by the user.

2. The server of claim 1 wherein the one or more communication services include a telephone service.

3. The server of claim 1 wherein the one or more communication services include an Internet service.

4. The server of claim 1 wherein the one or more communication services include a television (TV) service.

5. The server of claim 1 wherein the programming code includes Java bytecode.

6. The server of claim 1 wherein the programming code includes a plugin.

7. The server of claim 1 wherein the one or more communication services include a plurality of communication services, and the at least one communication service includes two or more of the plurality of communication services.

8. A communication system, comprising:
an interface for receiving, from a user, programming code for realizing a service application which affects one or more communication services subscribed by the user, the received programming code including a particular programming function; and
a processor configured to modify a portion of the received programming code corresponding to the particular programming function, resulting in a modified version of the received programming code, which is executed to realize the service application.

9. The system of claim 8 wherein the received programming code is modified to incorporate an additional programming function into the received programming code.

10. The system of claim 9 wherein the additional programming function incorporates a security measure.

11. The system of claim 8 wherein the selected programming function is represented by Java bytecode.

12. The system of claim 11 wherein the received programming code is modified by instrumentation of the Java bytecode.

13. The system of claim 8 wherein the one or more communication services include a plurality of communication services.

14. A method for use in a communication system employed by a communication service provider to provide communication services, comprising:
receiving, through a communication link initiated by a customer of the communication service provider, programming code for realizing a service application which involves providing selected information to the customer through at least one of the communication services which is subscribed by the customer; and
processing the programming code to realize the service application.

15. The method of claim 14 wherein the selected information includes a notification of an occurrence of a certain event.

16. The method of claim 14 further comprising monitoring a second communication service subscribed by the customer for the certain event.

17. The method of claim 16 wherein the second communication service includes a telephone service, and the certain event includes a certain telephone call event.

18. The method of claim 14 wherein the selected information is provided in video form.

19. The method of claim 16 wherein the at least one communication service includes a TV service.

20. The method of claim 14 wherein the communication link is established through an Internet.
